(19) United States
(12) Patent Application Publication
(10) Pub. No.: US 2014/0188544 A1
(43) Pub. Date: Jul. 3, 2014

(54) Method and System for Automatically Generating Information Dependencies

(71) Applicant: The Board of Trustees for the Leland Stanford Junior, University, (US)

(72) Inventor: Reid R. Senescu, Stanford, CA (US)

(73) Assignee: The Board of Trustees for the Leland Stanford Junior, University, Palo Alto, CA (US)

(21) Appl. No.: 13/733,800

(22) Filed: Jan. 3, 2013

(51) Int. Cl. G06Q 10/06

(52) U.S. Cl. CPC G06Q 10/0633
USPC 705/7.27

(57) ABSTRACT

A method according to an embodiment of the present invention infers a network of information dependence in real-time by capturing the manner in which computer users interact with files. For example, in an embodiment, such dependencies are represented as a sparse directed network. In another embodiment of the present invention, In another embodiment of the present invention, the dependencies are embedded in an operating system or document management system at a level commensurate with the manner in which professionals use Windows Explorer.

### FIELD OF THE INVENTION

The present invention generally relates to computerized methods and systems for generating information dependencies.

### BACKGROUND OF THE INVENTION

With the development of technologies for business process improvement such as Design Structure Matrix (DSM), researchers have been contributing methods to improve the planning and control of assembly and information workflows. Even with these contributions, DSM remains a complementary tool used by a small fraction of industry projects and by a small fraction of the people on the projects in which it is implemented. The lack of prevalence of business process improvement methods is not due to the lack of value it provides, but rather the up-front implementation effort and associated cost, for example.

Professionals can more easily apply business process improvement methods, for example, to manual processes (e.g., construction or manufacturing) because their non-iterative nature is more amenable to planning and control. The iterative nature of information work makes application for planning and control more rewarding but more difficult. The return on investment (ROI) for applying business process improvement to information work is positive but difficult to quantify due to the opacity of information workflows.

DSM, for example, was generally developed to model task dependencies. Others have applied DSM to manufacturing and have extended DSM to include different degrees of dependency. Others have extended DSM beyond task modeling for use in Data Flow Diagrams to model information dependencies via the Design Product Model (DPM). Based on DPM, the Analytical Design Planning Technique (ADePT) is a tool that, when combined with Last Planner, enables process planning and control. The resulting DePlan provides a comprehensive method for design process management. Implementing DePlan requires developing a DSM which costs hours of effort invested early in the project. Despite the benefits of implementing DePlan, there exist significant costs that limit its use.

### SUMMARY OF THE INVENTION

Revealing information dependencies among electronic documents or files has been shown to improve collaboration within teams and process sharing among teams. A method according to an embodiment of the present invention infers information dependence in real-time by capturing the manner in which computer users interact with files. For example, in an embodiment, such dependencies are represented as a sparse directed network or a Design Structure Matrix (DSM). In another embodiment of the present invention, the dependencies are embedded in an operating system or document management system at a level commensurate with the manner in which professionals use Windows Explorer.

In another embodiment, an office environment is provided with files structured in both a network of information dependencies as well as a traditional hierarchy of folders. An embodiment of the present invention provides real-time visualization of workflows via information dependence. By enabling improved understanding of workflows, embodiments of the present invention catalyze widespread application of business process improvement methods that improve workflow.

These and other embodiments are described in further detail below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a networked system on which the present invention can be practiced.

FIG. 2 is a schematic view of a computer system on which the present invention can be practiced.

FIG. 3 is an illustration of the manner in which documents are related according to an embodiment of the present invention where each person creates a new document that depends on information from a previously created document.

FIG. 4 is an illustration of a directed graph as implemented according to an embodiment of the present invention.

FIG. 5 is method for automatically generating information dependencies according to an embodiment of the present invention.

FIG. 6 is an illustration of a method for determining file dependency according to an embodiment of the present invention.

FIG. 7 is an illustration of a method for determining file dependency according to an embodiment of the present invention.

FIG. 8 is an illustration of a graphical user interface according to an embodiment of the present invention.

FIG. 9 is an illustration of a slider control for adjusting a threshold time according to an embodiment of the present invention.

FIG. 10A through 10C are various graphs illustrating certain features and results according to several embodiments of the present invention.

FIG. 11 is a table (Table 1) tabulating the number of inputs/outputs to/from files (respectively) with a minimum of one input/output for w*(i,j,t*)=0.014 according to an embodiment of the present invention.

FIG. 12 is a table (Table 2) that compares results according to an embodiment of the present invention with reported dependencies.

### DETAILED DESCRIPTION

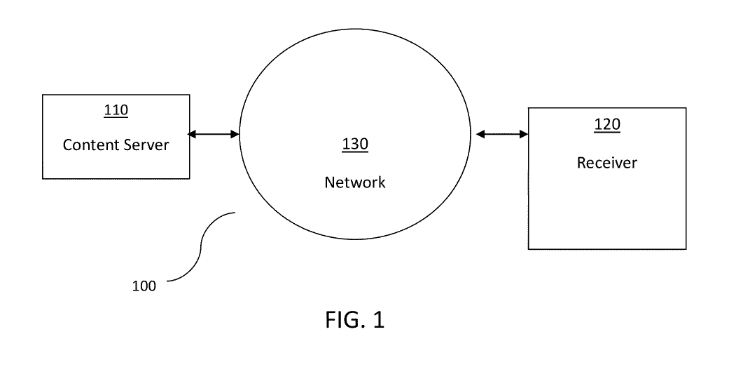

Among other things, the present invention relates to methods, techniques, and algorithms that are intended to be implemented in a digital computer system. By way of overview that is not intended to be limiting, digital computer system 100 as shown in FIG. 1 will be described. Such a digital computer or embedded device is well-known in the art and may include variations of the below-described system.

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

Further, certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (CSharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

FIG. 1 depicts an exemplary networked environment 100 in which systems and methods, consistent with exemplary embodiments, may be implemented. As illustrated, networked environment 100 may include a content server 110, a receiver 120, and a network 130. The exemplary simplified number of content servers 110, receivers 120, and networks 130 illustrated in FIG. 1 can be modified as appropriate in a particular implementation. In practice, there may be additional content servers 110, receivers 120, and/or networks 130.

In certain embodiments, a receiver 120 may include any suitable form of multimedia playback device, including, without limitation, a computer, a gaming system, a smart phone, a tablet, a cable or satellite television set-top box, a DVD player, a digital video recorder (DVR), or a digital audio/video stream receiver, decoder, and player. A receiver 120 may connect to network 130 via wired and/or wireless connections, and thereby communicate or become coupled with content server 110, either directly or indirectly. Alternatively, receiver 120 may be associated with content server 110 through any suitable tangible computer-readable media or data storage device (such as a disk drive, CD-ROM, DVD, or the like), data stream, file, or communication channel.

Network 130 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network, depending on the requirements of each particular implementation.

One or more components of networked environment 100 may perform one or more of the tasks described as being performed by one or more other components of networked environment 100.

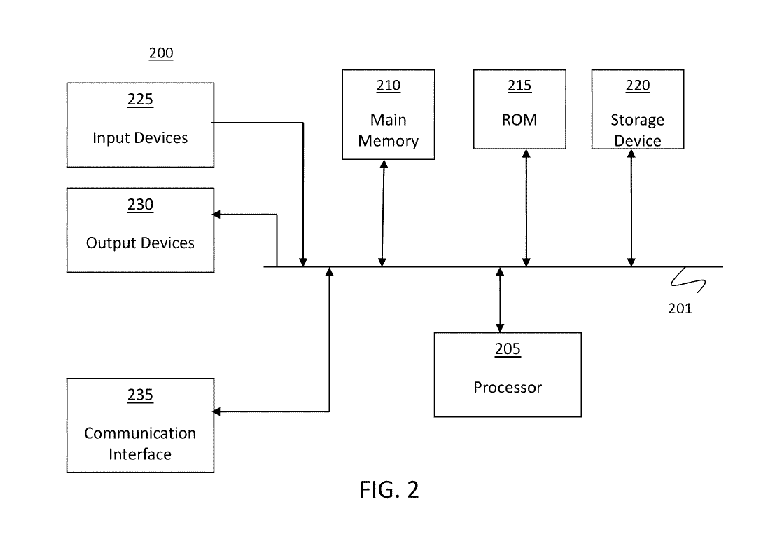

FIG. 2 is an exemplary diagram of a computing device 200 that may be used to implement aspects of certain embodiments of the present invention, such as aspects of content server 110 or of receiver 120. Computing device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of computing device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205. Storage device 220 may include a magnetic and/or optical recording medium and its corresponding drive.

Input device(s) 225 may include one or more conventional mechanisms that permit a user to input information to computing device 200, such as a keyboard, a mouse, a pen, a stylus, handwriting recognition, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables computing device/server 200 to communicate with other devices and/or systems. For example, communication interface 235 may include mechanisms for communicating with another device or system via a network, such as network 130 as shown in FIG. 1.

As will be described in detail below, computing device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present invention. Thus, various implementations are not limited to any specific combination of hardware circuitry and software.

A web browser comprising a web browser user interface may be used to display information (such as textual and graphical information) on the computing device 200. The web browser may comprise any type of visual display capable of displaying information received via the network 130 shown in FIG. 1, such as Microsoft's Internet Explorer browser, Google's Chrome browser, Mozilla's Firefox browser, PalmSource's Web Browser, Google's Chrome browser or any other commercially available or customized browsing or other application software capable of communicating with network 130. The computing device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the computing device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present invention described herein are discussed in the context of the global data communication network commonly referred to as the Internet. Those skilled in the art will realize that embodiments of the present invention may use any other suitable data communication network, including without limitation direct point-to-point data communication systems, dial-up networks, personal or corporate Intranets, proprietary networks, or

Turning now to more particular issues relating to embodiments of the present invention, the development of business process improvement technology often focuses on improving the planning of information workflows. Users may place relatively less emphasis on the stand-alone value of revealing the network structure of information or task dependencies during workflow execution. But bringing transparency to workflows enables improved collaboration within teams and process sharing among teams. For example, among other things, the process integration platform as disclosed in co-pending application Ser. No. 13/253,924, entitled “Design Process Communication Method and System,” herein incorporated by reference for all purposes, enables teams to visualize and exchange digital files as nodes in an information dependency network that teams create as they work.

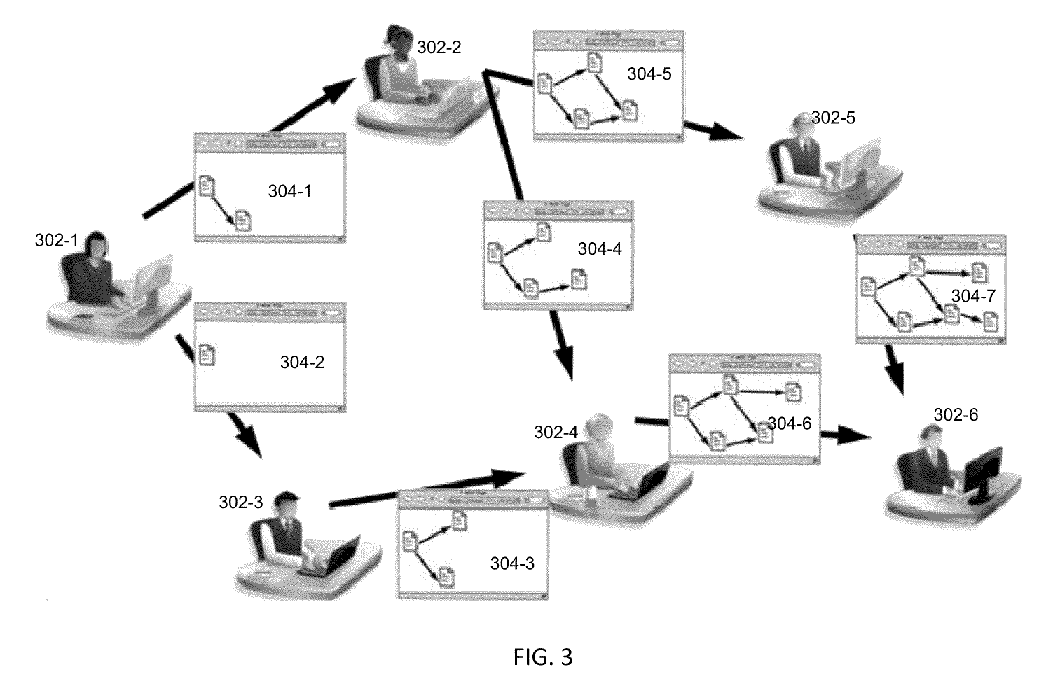

Because digital files are frequently the core deliverable in many situations, revealing the dependencies among files can also reveal workflows. For example, shown in FIG. 3 is a group of users 302 that are part of a workgroup for a large task. In performing certain of their assigned tasks, such users create, edit, and use documents. For example, a document created by user 302-1 may be used by user 302-3 to create a second document as shown in screen 304-1. Also, user 302-2 may use the same document created by user 302-1 to create one other documents as shown in screen 304-3. So it can be appreciated that through the course of a complex project, for example, many documents can be related to many other documents in a complex way. If such relationships are understood, however, a better workflow can be implemented. For example, by understanding that a document uses information from a collection of other documents, a user may desire to update a document if he becomes aware of changes in other documents.

Embodiments of the present invention build upon DPM's establishment of a relationship between information and tasks in that teams enabled with a process integration platform tie descriptions of information with the actual files. Also, since files are often a professional's deliverables, the representation of file dependencies documents information interactions. In prior art method, computer users have been required to manually define the dependency network. Embodiments of the present invention, however, automate this task. More particularly, an embodiment of the present invention provides a method for automating the generation of a file-based dependency network by unobtrusively capturing the manner in which professionals open (e.g., read) and create/edit (e.g., write) digital files.

Consistent with the information processing view of an organization, it has been observed that professionals frequently view information (e.g., files, website, e-mails, etc.) that they or someone else created in the process of generating other documents. For example, it has been observed that if a computer user uses certain viewed information within a specified amount of time, to create or edit another piece of output information, the viewed and edited documents may be related.

An embodiment of the present invention uses a file-based model of project workflows where files and dependencies are represented as vertices and directed edges, respectively, in a network. In this way, a file-processing view of a project team is created. Treating the business process improvement problem as the adjacency matrix of a network allows for the use of concepts from network analysis and network inference in predicting file dependencies.

Here, we summarize directed graphs as known to those of ordinary skill in the art. Generally, a directed graph (or digraph) is a pair G=(V, E) where V is a set of vertices and E is a subset of V×V called edges or arcs. If E is symmetric (e.g., (u, v) ∈ E if and only if (v, u) ∈ E), then the digraph is said to be isomorphic to an ordinary (e.g., undirected) graph.

Digraphs are generally drawn in a similar manner to graphs with arrows on the edges to indicate a sense of direction. For example, the digraph

({a,b,c,d}, {(a,b),(b,d),(b,c),(c,b),(c,c),(c,d)})

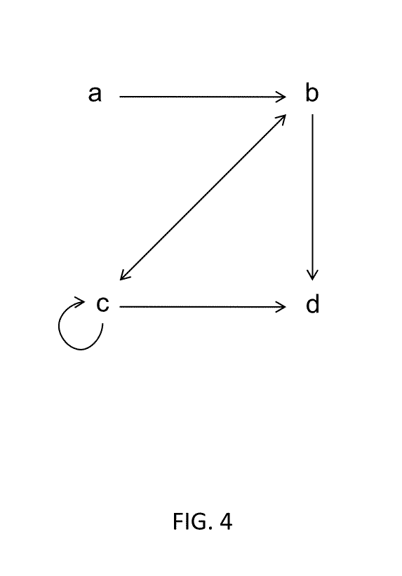

may be drawn as shown in FIG. 4. Moreover, note the manner in which the arrows (e.g., edges) of FIG. 3 include a sense of direction for the manner in which information flows from one document to another. In this way, it can be appreciated that a directed graph lends itself well to an embodiment of the present invention. It should be noted, however, that other embodiments of the present invention can be implemented without directed graphs. For example, another embodiment of the present invention identifies relatedness without direction (e.g., undirected graph).

Since the graph is directed, it has the concept of the number of edges originating or terminating at a given vertex v. The out-degree, dₒᵤₜ(v) of a vertex v is the number of edges having v as their originating vertex; similarly, the in-degree, dᵢₙ(v) is the number of edges having v as their terminating vertex.

If the graph has a finite number of vertices, say v₁, . . . , vₙ, then

Σᵢ₌₁ⁿdᵢₙ(vᵢ)=Σᵢ₌₁ⁿdₒᵤₜ(vᵢ

A directed path in a digraph G is a sequence of edges e₁, . . . , eₖ such that the end vertex of eᵢ is the start vertex of eᵢ₊ᵢ for i=1, 2, . . . , k-1. Such a path is called a directed circuit if, in addition, the end vertex of eₖ is the start vertex of e₁.

A digraph is connected (or strongly connected) if, for every pair of vertices u and v, there is a directed path from u to v. In addition, a digraph G=(V, E) is said to have a root r ∈ V if every vertex v ∈ V is reachable from r, e.g., if there is a directed path from r to v.

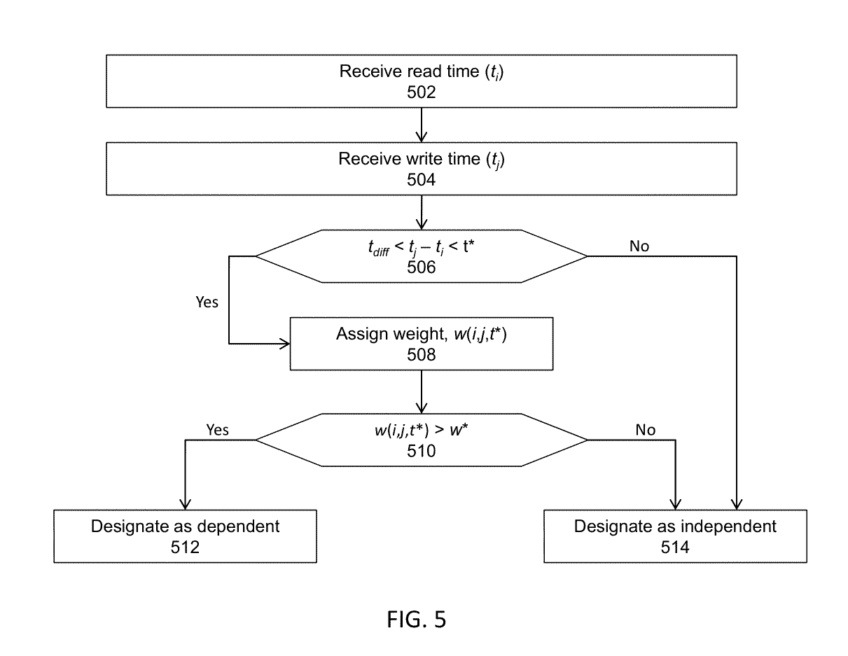

An embodiment of the present invention provides a method for the automatic generation of information dependency as shown in the flowchart of FIG. 5 using a directed graph. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

An embodiment of the present invention was implemented on the information management tool Bentley ProjectWise. Using Bentley ProjectWise, file dependencies were inferred based on data logs. Such an embodiment will be described as a case study further below.

In an embodiment of the present invention, a file dependency is designated when the creation or editing of a file j (e.g., writing to j) requires that information is taken from a file i (e.g., reading i). For example, as shown in FIG. 5, at step 502, a read time, tᵢ, is received for the time that file i is read. At step 504, a write time, tⱼ, is received for the time that file i is written. As used herein, the terms read and write are intended to be used in their broadest forms. For example, a read can be a viewing of a document. In another embodiment, a read can be the copying of information from a document. In an embodiment, a write can be the manual entering of text in a document. In another embodiment, writing can be the pasting of information into a document. Still in another embodiment, a write can be the saving of a document to a media such as a hard disk. Many other possibilities are known to those of ordinary skill in the art.

The time between writing file j and reading file i is t_{diff}. It has been found that there exists a preferred predetermined time difference, t*, that provides a reasonable threshold for a dependency model. For example, consider that if t_{diff} is large (e.g., one year), it is unlikely that the file j depends on file i. But as t_{diff} decreases to zero, the likelihood of dependency increases. For example, where a computer user immediately writes to file j after viewing file i, there is a high likelihood that the files are dependent because, in this situation, the computer user would have been working with the two files simultaneously. It has been found that there exists a predetermined threshold time, t*, where the modeled dependency network best represents a dependency network of the documents.

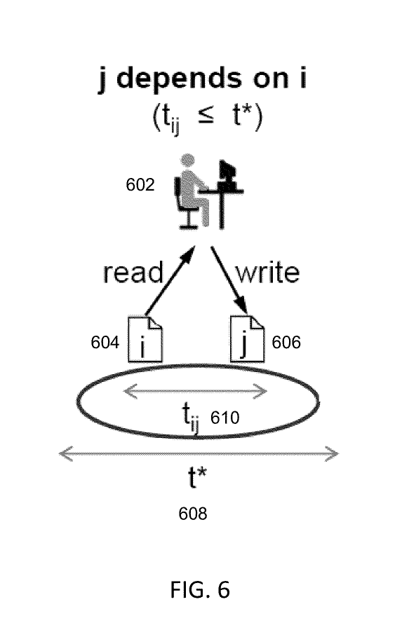

It is such value, t*, that is used for the threshold determination at step 506 of FIG. 5. For example, where a t_{diff} is determined to be less than the predetermined value t*, an edge between documents i and j is created and a weight (e.g., a positive weight), w(i j,t*), is assigned at step 508. This concept is further graphically shown in FIG. 6. As shown in FIG. 6, a computer user reads a file i 604 at a particular time and writes to a file j 606 within a time t_{diff} 610 that is less than a predetermined threshold time t* 608. In such a situation according to an embodiment of the present invention, the files i and j are assigned a dependency weight, w(i,j,t*).

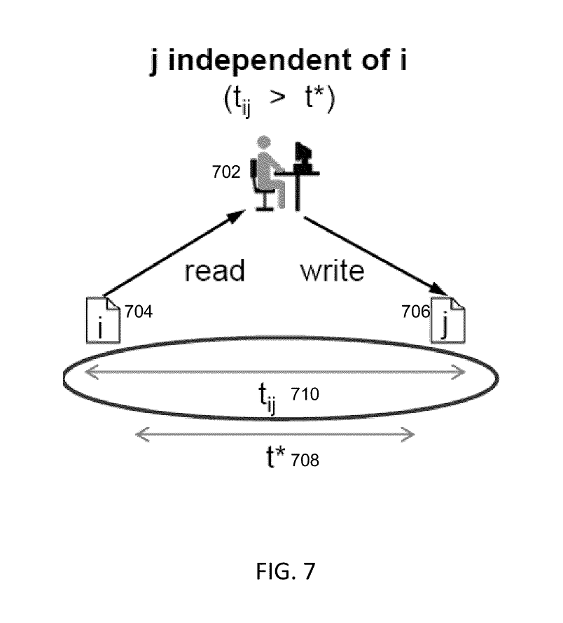

With further reference to FIG. 5, where a t_{diff} is determined to be greater that the predetermined value t* at step 506, the documents i and j are designated a weight of zero and are further designated as independent at step 514. This concept is further graphically shown in FIG. 7. As shown in FIG. 7, a computer user reads a file i 604 at a particular time and writes to a file j 606 within a time t_{diff} 610 that is greater than a predetermined threshold time t* 608. In such a situation according to an embodiment of the present invention, the files i and j are considered to be independent. In another embodiment of the present invention, the documents are not necessarily designated as independent. Instead, the absence of a designation that the files are dependent provides information that the files are independent.

Where the present invention is implemented as a directed graph, a dependency weight is applied to a directed edge from i to j when a computer user reads a file i and then writes a file j in a time t_{diff}<t*. In an embodiment, the weight of this edge, w(i,j,t*), is based in part on the number of times the workflow is repeated (e.g., number of times i is read and j is written within the predetermined time t*). In such an embodiment, the weight w(i,j,t*) can represent a level of confidence that a dependency exists from file i to file j. In this embodiment, w* generally represents a predetermined weight threshold. In such an embodiment, the weight of the edge of the dependency graph is assigned at step 508. It should be noted that other criteria can be used in assign a weight to an edge. For example, where the timing of certain views (or windows) can be measured, such information can be used in the assigned weight. Moreover, where copy and paste functions can be measured, they can provide an excellent metric for determining file dependencies. Also, mouse, scrolling or typing activity may be used for determining file dependencies. Many other criteria can be used as would be obvious to those of ordinary skill in the art.

At step 510, the weight w(i,j,t*) is compared to a predetermined threshold weight, w*. Where w(i,j,t*) is greater than the predetermined threshold w*, files i and j are designated as dependent at step 512. But where, w(i,j,t*) is less than the predetermined threshold w*, files i and j are designated as independent at step 514.

A method according to an embodiment of the present invention, therefore, predicts that the existence of a dependency from file i to file j (e.g., a dependency with a direction). With respect to a directed graph, a method according to an embodiment of the present invention identifies the existence of an edge within a directed network. Moreover, a method according to the present invention assigns a weight to such edge (e.g., w(i,j,t*) w*).

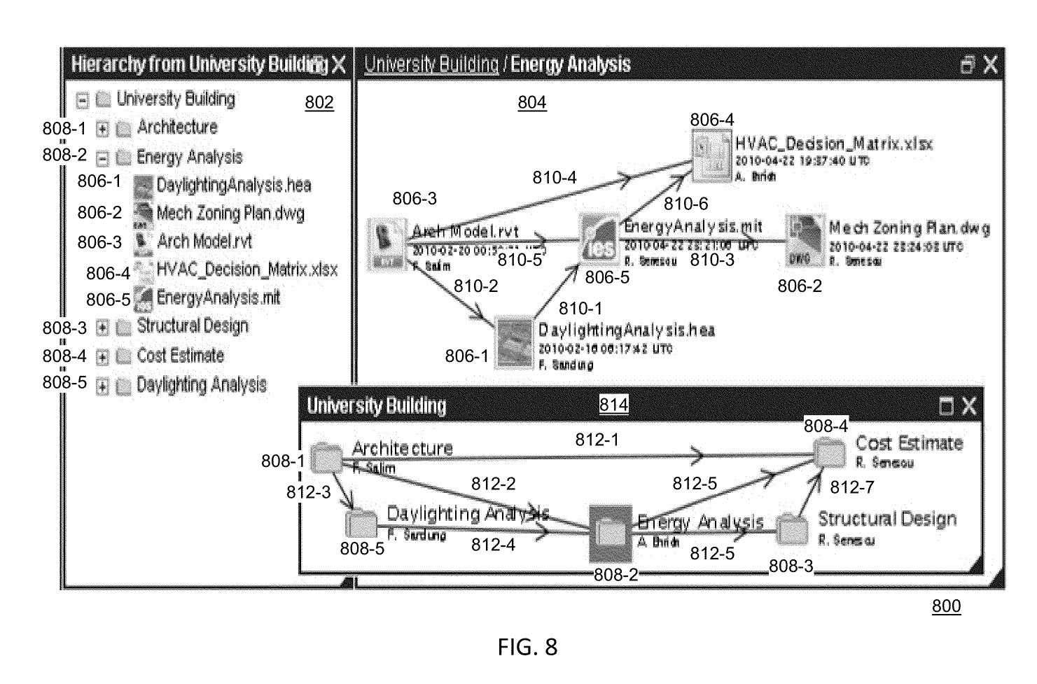

With the present disclosure, one of ordinary skill in the art could modify the present invention to achieve many variations. For example, in an embodiment of the present invention, the dependencies of the various files can be graphically shown on a screen. Moreover, such dependencies could be used to complement traditional graphical representations of files. For example, screenshot 800 is shown in FIG. 8 that includes a traditional Windows Explorer view 802 that includes a hierarchical representation of files within folders. For example, within the folder “Energy Analysis” 808-2 are various files 806-1 through 806-5 represented in a traditional Windows Explorer view 802 in a hierarchical format.

Further shown in FIG. 8, however, is dependency representation 804 according to an embodiment of the present invention that illustrates the manner in which the various files 806-1 through 806-5 are dependent among each other. For example, arrow 810-1 is provided as a directed representation that file 806-5 is dependent on information from file 806-1. Arrows 810-2 through 810-6 show other directed relationships among files.

In another embodiment, the relationship among folders is illustrated. For example, also shown in FIG. 8 is dependency relationship 814 among the various folders 808-1 through 808-5. For example, arrow 812-1 is provided as a directed representation that folder 808-4 is dependent on information from folder 806-1. Arrows 812-2 through 812-7 show other directed relationships among folders.

In another embodiment of the present invention, the various files within dependency representation 804 are presented along a timeline representing the times when the files were being edited. Such an embodiment provides a graphical representation of when certain files were in a state of change. In still another embodiment, the files are presented along a timeline representing the time of the last change for a document. Similar embodiments can be implemented for dependency representation 814.

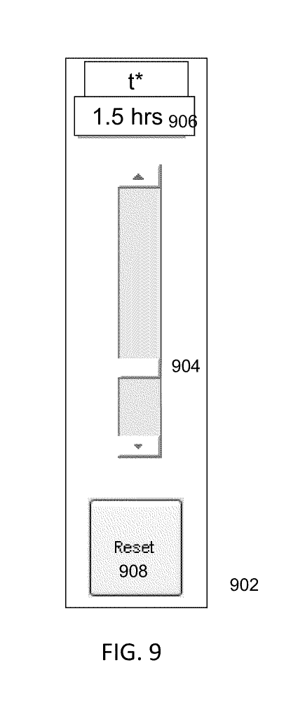

In still another embodiment of the present invention, the threshold value t* is made available as a user selectable value. For example, as shown in FIG. 9, a slider bar 904 is made available on a user interface 902 for selecting a threshold value t*. In an embodiment, a numeric representation 90 of the selected value is provided as well as a reset button 908 that returns the threshold value t* to a predetermined value.

In still another embodiment of the present invention, related files could be listed. In still another embodiment, related files could be shown in a matrix. Also, related files could be shown responsive to a search query.

In yet another embodiment of the present invention, a dependency designation or weight can be made based on other factors. For example, a dependency determination or weight can be varied based on the manner of transferring information from one document to another. For example, an embodiment of the present invention can detect whether a document is at the fore of a computer users interface and can make a dependency determination based on computer user views. In another embodiment of the present invention, detection can be made of copy and paste actions. For example, where information was copied from one document to another, even if it is not within a predetermined time, a dependency can be established. Moreover, a weight (e.g., increased weight) can be assigned responsively.

It should further be noted that determination of a predetermined threshold time, t*, can be substantially dependent on the type of system on which the present invention is implemented. For example, an implementation records read and edit times with fine granularity, a predetermined threshold time can be expected to be different from an implementation with coarse granularity in time measurements.

An embodiment of the present invention that was implemented on Bentley ProjectWise was evaluated as a case study. It should be noted that the described case study is illustrative and does not limit the present invention. In the case study, a team was designing a new US$1 billion, 46,400 m² hospital in California. The team had already adopted a cloud-based information management tool called Bentley ProjectWise. ProjectWise enabled the 53 companies and 246 team members working on the project to store and exchange files in a common location. During the hospital design phase (April 2010 to February 2012), ProjectWise logged 625,808 interactions with 28,376 files. Interactions that created or checked in (with changes) files were considered to be writing; viewing or exporting files were considered to be reading. Using this data, a method according to an embodiment of the present invention was applied to calculate dependency matrices for 24 different values of t* ranging from 1 second to 21 days.

This embodiment was then tested by gathering information about the true dependency matrix from an independent sample of file interactions. To determine the true matrix, a survey was created that asked:
1. Think of a time in 2012 you used information from one file to create or edit another file. Please paste a link (i.e., file path) to the file that you created or edited in 2012.
2. Please paste a link (i.e., file path) to a file from which you used information to create or edit this file [filename from 1. inserted here]
3. Now, please paste a link (i.e., file path) to a file you created/edited that you did NOT use to create/edit this file [filename from 1. inserted here]. Note: There may be many files to choose from (This is not a trick question).
   This format enabled conservative assessment of the accuracy of this embodiment of the present invention.

To validate this embodiment of the present invention, surveyees stated whether or not file j truly depends on file i. Four possibilities exist:
1. True Positive (TP): AIDA predicted dependent, surveyee reported dependent
2. False Positive (FP): AIDA predicted dependent, surveyee reported independent
3. True Negative (TN): AIDA predicted independent, surveyee reported independent
4. False Negative (FN): AIDA predicted independent, surveyee reported dependent

The hit rate (also called the sensitivity or true positive rate and defined as TP/(TP+FN)) indicates the ability to accurately predict true dependencies. The false alarm rate (also called the false positive rate or 1—specificity and defined as FP/(FP+TN)) indicates occurrences where this embodiment incorrectly predicts file dependencies when the files are actually independent.

Using an embodiment of the present invention, file j is predicted to depend on file i if w(i,j,t*) [symbol] w*. If the weight threshold is 0 (e.g., w*=0), then every file depends on every other file. Hence, hit rate=100%, but the false alarm rate=100%. If w* is greater than the maximum calculated w for a particular set of file interactions, then zero file dependencies are predicted. Hence, the false alarm rate=0, but the hit rate=0. As w* varies between those extremes, tradeoffs exist between false alarm rate and hit rate.

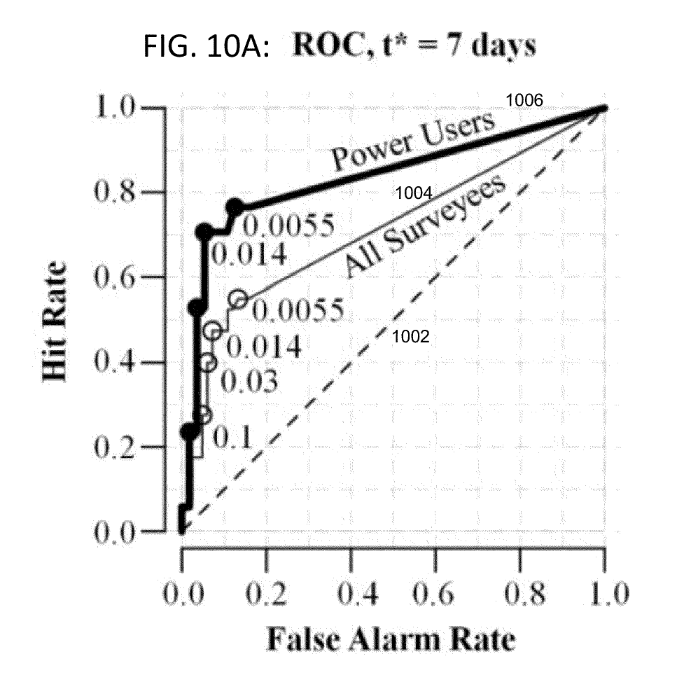

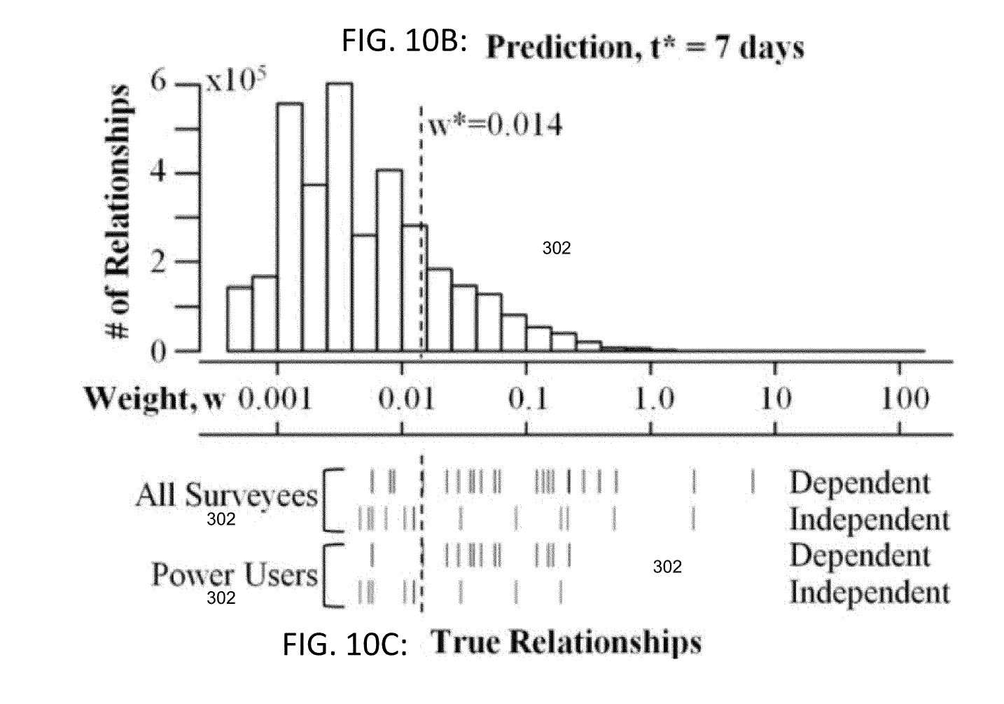

A receiver operating characteristic (ROC) curve is a graphical representation of this tradeoff. If w(i,j,t*) is unrelated to the true file structure, the hit rate would equal the false alarm rate, so the ROC curve would follow the 45 degree line 1002 as shown in FIG. 10A. This possibility that w(i,j,t*) is unrelated to the true file relationships can be treated as a null hypothesis from which a p-value can be calculated. Area under the curve (AUC) is also a useful measure as random guessing would result in AUC=0.5 whereas a perfect prediction would result in AUC=1.

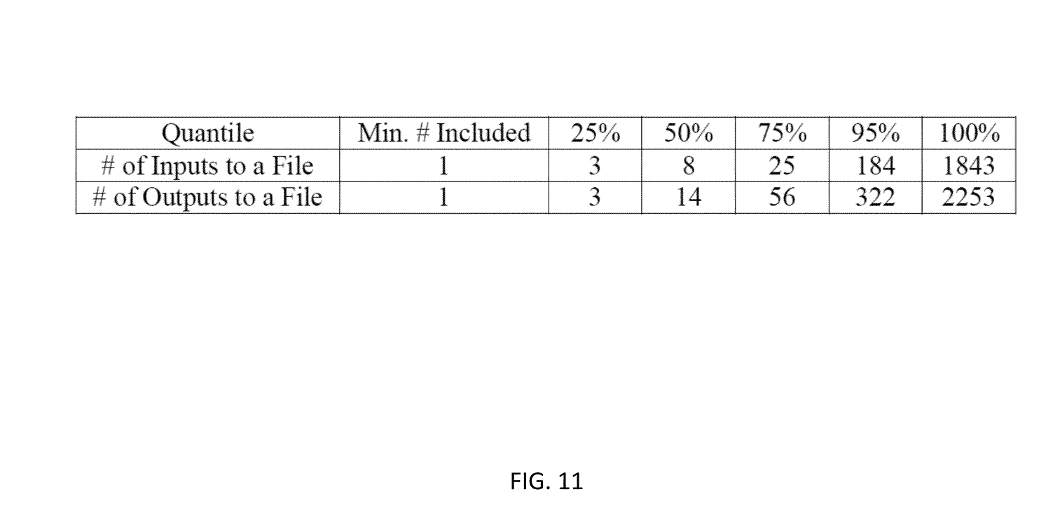

Out of the 28,376×28,376 theoretically possible dependencies, executing a method according to an embodiment of the present invention resulted in a prediction of 746,092 dependencies for t*=7 days and w*=0.014. As shown FIG. 11 (Table 1), these predicted dependencies were not distributed normally across pairs of files. According to this embodiment, half of all the files with at least one input had eight or fewer files on which the file depended. Half of all files with at least one output were used by other files 14 times or fewer. These input/output numbers are sufficiently small such that if accurate, they could prove useful to project teams attempting to better understanding their workflows.

According to this embodiment of the present invention, 6,815 files neither depended on other files nor were used to create/edit other files (e.g., 6,815 files were isolated from the dependency network). In outlier situations, 14 files were predicted to have over 1000 other files dependent on each of them. For such outlier situations, another embodiment of the present invention is configured to filter anomalous results.

During eight days in February 2012, 19 surveyees responded from eight companies and named 40 dependent file pairs and 83 independent file pairs. Surveyees represented diverse roles including the Building Information Modeling Coordinator, Electrical Engineering Designer, Mechanical Subcontractor, Project Manager, Drywall Modeler, Project Architect, Low Voltage Designer, etc.

To evaluate the effectiveness of an embodiment of the present invention, the ROC curve was reviewed for every value of t*. The t* and w* pair that gave the highest hit rate while maintaining a false alarm rate<0.1 was chosen for evaluation. This selection criteria resulted in t*=7 days and w*=0.014. As shown by the line 1004 in FIG. 10A, at w*=0.014, the hit rate=0.48 and the false alarm rate=0.07. The ROC curve has an AUC of 0.71, and a p-value=1.07×10⁻⁶. The AUC and p-value indicate that it is extremely unlikely that the method according to an embodiment of the present invention is unrelated to true file dependencies. In this situation, the hit rate can be considered to be too low to be practically useful.

With a lower threshold (e.g., w*=0.002) at t*=21 days, a higher hit rate (0.65) and higher AUC (0.75) are obtained, but at the cost of a false alarm rate=0.17. That is, on that ROC curve (not shown) 17% of the file pairs that are predicted to be dependent are actually independent. This finding reiterates the importance of the ROC curve itself, since this tradeoff for a higher hit rate results in a false alarm rate too great to be practically useful.

Looking into the misses, it was observed that some surveyees used ProjectWise infrequently while certain power users used ProjectWise multiple times per day. Discussions with team members provided anecdotal evidence that these infrequent users used other tools for exchanging information. An improved embodiment of the present invention would therefore capture more of these file or information exchanges. To test this hypothesis, the ROC analysis was performed again considering only the seven surveyees that were in the top ten of all ProjectWise users. It was found that at w*=0.014 the hit rate jumped to 71% and the false alarm rate declined to 5% (see bold line 1006 in FIG. 10A). Furthermore, the AUC increased to 0.83 (p-value=1.73×10⁻⁷). Based on these results, it is anticipated that as more of the total information exchange on a project is captured, the accuracy of embodiments of the present invention will increase.

Shown in FIG. 10B is a graphical illustration that by applying a threshold of w*=0.014, the majority of potential pairs (0 [symbol] w(i,j,t*=7 days)<0.014) are considered independent. The existence of some weights as high as 117 imply that some users continuously read and write to the same file pairs, suggesting a repeated workflow and a high confidence of dependence.

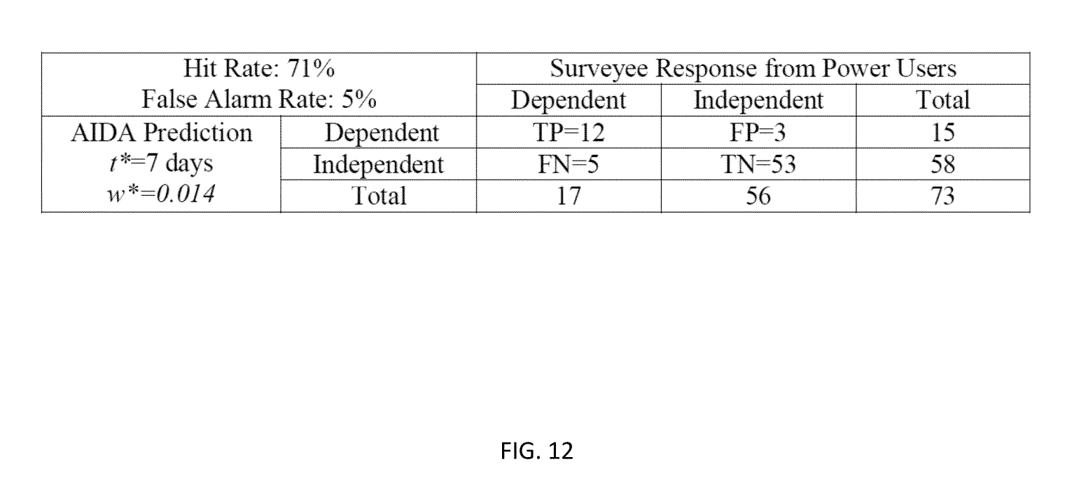

FIG. 10C further illustrates AIDA's increased accuracy when applied only to power users. Each vertical line of FIG. 10C represents a surveyee response. For example, the three lines to the left of the w*=0.014 dashed line (top left) represent false negatives; file pairs surveyees said were dependent, but that the method according to an embodiment of the present invention predicted to be independent. In total, there are 21 false negatives (18 occurred at w=0 and are not visible on the log x-axis) and 77 true negatives (70 at w=0). For power users, there were only 5 false negatives (4 at w=0) with 53 true negatives (47 at w=0). This decrease in false negatives is the primary cause for the increased Power User hit rate. Shown in FIG. 12 (Table 2) is a tabular comparison of predictions with surveyee reported dependencies/independencies.

For the case study, the true network structure is not known, and it is impractical to obtain a uniform sample of the full network. The survey was designed to minimize the impact of these circumstances. But since a surveyee does not know whether a file they wrote is depended upon by another file created by someone else, the surveyees are sampling pairs of files from sub-networks which are much denser on average than the full network. Hence, the 5% false alarm rate and 71% hit rate exist on dense subsets of the network. Across the entire network, the method according to an embodiment of the present invention predicts that each file is connected on average to 26.3 other files (a graph density of 0.093%). The calculated false alarm rate is conservatively based on the sub-networks, whereas across the entire graph, the false alarm rate is necessarily less than 0.093%. On the other hand, it is possible that the hit rate is optimistic since a denser than average portion of the graph is sampled, especially since some users downloaded (i.e., read) many files at a time.

If such an overestimation exists, it is a consequence of the captured data—the way users interacted with ProjectWise, not the method according to an embodiment of the present invention. The dramatic increase in hit rate when only considering power users suggests that a more comprehensive embodiment capturing of user interactions with files could result in an even higher hit rate (perhaps >95%) with a small (perhaps <0.1%) false alarm rate.

Opportunity in other embodiments also exists to consider more sophisticated network analysis research on link prediction in estimated and partial networks. Link prediction considers the case where a partial network is known. For example, Facebook has an observed friendship network with relatively few strangers listed as “friends” (false positives), but many friends who are not listed as “friends” (false negatives). Facebook tries to correct these false negatives by recommending users as “friends” based on the observed network structure (link prediction). Similarly, an embodiment of the present invention infers much of the network with only a small false positive rate, and other embodiments can be extended using link prediction to find other potential information dependencies to improve the hit rate.

Above has been described embodiments for automatically generating information dependency. A method according to an embodiment of the present invention captures the dependencies among information based on how users interact with digital files. In another embodiment of the present invention, the dependencies are embedded in an operating system or document management system at a level commensurate with the manner in which professionals use Windows Explorer.

It should be appreciated by those skilled in the art that the specific embodiments disclosed above may be readily utilized as a basis for modifying or designing other techniques for carrying out the same purposes of the present invention. It should also be appreciated by those skilled in the art that such modifications do not depart from the scope of the invention as set forth in the appended claims.

We claim:

1. A computer-implemented method for automatically determining dependencies among digital information, comprising:
receiving a read time for a first document;
receiving a write time for a second document;
determining a difference between the write time and the read time; and
designating that the second document depends from the first document when the difference between the write time and the read time is less than a predetermined threshold time.

2. The method of claim 1, further comprising assigning a weight for a dependence from the first document to the second document.

3. The method of claim 2, wherein the weight for the dependence from the first document to the second document is a weight in a directed or undirected graph.

4. The method of claim 2, wherein the weight for the dependence from the first document to the second document is computed responsive to a number of times a document is written within the predetermined threshold time.

5. The method of claim 2, wherein the weight for the dependence from the first document to the second document is computed responsive to a command executed in either the first document or the second document.

6. The method of claim 5, wherein the command is a paste command executed on the second document.

7. The method of claim 1, wherein the designation that the second document depends from the first document is represented as an edge in a directed or undirected graph.

8. The method of claim 1, wherein the predetermined threshold time is chosen to represent a dependency network.

9. The method of claim 1, wherein the predetermined threshold time is received from a user.

10. The method of claim 1, further comprising graphically representing the designation that the second document depends from the first document

11. A computer-readable medium including instructions that, when executed by a processing unit, cause the processing unit to automatically determine dependencies among digital information, by performing the steps of:
receiving a read time for a first document;
receiving a write time for a second document;
determining a difference between the write time and the read time; and
designating that the second document depends from the first document when the difference between the write time and the read time is less than a predetermined threshold time.

12. The computer-readable medium of claim 11, further comprising assigning a weight for a dependence from the first document to the second document.

13. The computer-readable medium of claim 12, wherein the weight for the dependence from the first document to the second document is a weight in a directed or undirected graph.

14. The computer-readable medium of claim 12, wherein the weight for the dependence from the first document to the second document is computed responsive to a number of times a document is written within the predetermined threshold time.

15. The computer-readable medium of claim 12, wherein the weight for the dependence from the first document to the second document is computed responsive to a command executed in either the first document or the second document.

16. The computer-readable medium of claim 15, wherein the command is a paste command executed on the second document.

17. The computer-readable medium of claim 11, wherein the designation that the second document depends from the first document is represented as an edge in a directed or undirected graph.

18. The computer-readable medium of claim 11, wherein the predetermined threshold time is chosen to represent a dependency network.

19. The computer-readable medium of claim 11, wherein the predetermined threshold time is received from a user.

20. The computer-readable medium of claim 11, further comprising graphically representing the designation that the second document depends from the first document

21. A computing device comprising:
a data bus;
a memory unit coupled to the data bus;
a processing unit coupled to the data bus and configured to
receive a read time for a first document;
receive a write time for a second document;
determine a difference between the write time and the read time; and
designate that the second document depends from the first document when the difference between the write time and the read time is less than a predetermined threshold time.
